(19) United States
(12) Patent Application Publication
(10) Pub. No.: US 2012/0249948 A1
(43) Pub. Date: Oct. 4, 2012

(54) TEMPLATE FOR PLACING ON AN EYE

(76) Inventor: Tobias Neuhann, Muenchen (DE)

(21) Appl. No.: 13/497,099

(22) PCT Filed: Sep. 9, 2010
(86) PCT No.: PCT/DE2010/001058

§ 371 Date: Mar. 30, 2012

Related U.S. Application Data
(60) Provisional application No. 61/277,480, filed on Sep. 25, 2009.
(60) Provisional application No. 61/264,978, filed on Nov. 30, 2009.

(30) Foreign Application Priority Data
Sep. 21, 2009 (DE) 10 2009 042 009.6

(51) Int. Cl. G02C 7/04

(52) U.S. Cl. 351/159.23; 351/159.02; 351/159.78; 351/159.74

(57) ABSTRACT

The invention relates to a template for placing on an eye, said template having a circular concavity on one side. The invention also relates to a template with a massage device and to a film for placing on an eye. The invention further relates to a method for producing such a template and to a use of such a template.

The invention relates to a template for placing on an eye.

Devices for placing on an eye, in the form of vacuum suction rings for tightening the cornea, are numerously known from the prior art. These so-called microkeratomes are placed on the eye and a vacuum is applied to the suction ring, whereby the cornea is tightened. The latter can thus be treated further operatively in this drawn straight form and further treated by means of a lasik treatment.

Devices for placing on the eye for the deformation of the cornea are also known from orthokeratology. The cornea can be deformed overnight by orthokeratological contact lenses, which leads to a refraction power correction and hence to a corrected vision by day. The hard contact lenses which are used for this are smooth on the outer side and are shaped on the inner side in accordance with the desired refraction power correction. Thereby, the cornea is moved into the desired shape.

It is an object of the present invention to provide an improved template for placing on an eye.

According to a first aspect of the invention, this problem is solved by a template for placing on an eye, wherein it has a circular concavity on one side. This concavity corresponds to the desired calculated corrected cornea shape which is necessary for a correction of an ametropia. The template is adapted to the ametropia which is to be treated. A treatment of myopia, hypermetropia, presbyopia and astigmatism is possible. An adaption to individual aberrations of the eye which is to be treated, which were determined for example within a wave-front analysis, can be carried out.

Such a template can be placed on the eye. The pressure conditions between the eye and the cavity formed between the cornea and the concavity are than altered so that the cornea is pressed into the concavity. This can either be achieved in that a vacuum is applied to the concavity, or in that a viscoelastic is injected into the interior of the eye, whereby the internal pressure in the eye increases.

It is advantageous if, around the first concavity, the template has a second concavity in the form of a region which is curved in a ring shape. The latter can either be shaped so that it is matched in mirror image to the pre-operative shape of the cornea in this region. It thus serves for sealing when the template is placed. A second possibility consists in shaping this second concavity so that it also serves for a vision correction. In this case, this concavity is also shaped so that it corresponds to the corneal curvature which is desired post-operatively.

It is advantageous if the template has a duct which is connected with the concavity. Through this duct, the air can be removed from the cavity formed by the concavity and the cornea.

This can take place by a device, for generating vacuum being arranged on the duct. Such a device can be, for example, a vacuum pump or a manually-operated suction cup or a balloon. These generate the vacuum in the cavity formed by the cornea and the concavity. This can be varied and held for a particular time.

In order to be able to generate a constant vacuum, the side of the template on which the concavity is situated can have a seal at the edge. This terminates with the cornea and thus prevents a reduction to the vacuum. This can be configured for example in the form of a silicone ring.

The template can be cylindrical. This shape lends itself owing to the spherical geometry of the eye.

It can have a diameter of 2 to 20 mm. Whereas for the treatment of age-related farsightedness (presbyopia) small diameters of 2 to 4 mm are possible, for the treatment of hypermetropia or myopia larger diameters of up to 20 mm are necessary, depending on the corneal region which is to be treated. In addition to the corneal region which is to be treated, a marginal region can also be necessary, which lies on'a portion of the cornea which is not to be treated, for sealing or for better support.

The concavity itself can have a diameter of 2 to 15 mm. This corresponds to the corneal region which is to be treated.

For the treatment of age-related farsightedness, it is helpful if the first concavity has a depth of 2 to 8 □m. This corresponds to the generally necessary correction of the corneal curvature.

The template can be produced from a variety of materials. Thus, for example, various plastics such as PMMA or silicone are conceivable. These materials have the advantage that the templates can be produced in the form of disposibles, i.e. they are used only once for treatment for each patient and are thereafter discarded. The templates can be adapted in their shape to the respective patient. The production from plastic has the advantage here that it is particularly light and is possible at a favourable cost.

A further conceivable material would be titanium. A production from titanium would have the advantage that the template has a low weight and would be reusable. In particular, a sterilisation is possible.

Other materials, such as steel for example, are also conceivable.

A further aspect of the invention, which is also essential to the invention by itself, relates to a template for placing on an eye, wherein the template has a massage device. With this, the cornea of the eye can be massaged in particular regions.

Advantageously, the massage device is circular and is therefore adapted to the geometry of the eye. It can, for example, be plunger-shaped and arranged so that it presses centrally onto the eyeball over the pupil. It can have a diameter of 2 mm to 20 mm.

The massage device can have at least one ring element. In particular, it can also be configured entirely in a ring shape. This has the advantage that the massage device can be placed around a template with a circular concavity. Also, however, a use of the massage device on its own is conceivable.

With a combined use of massage device and template part with a concavity, it is possible to construct the part with the concavity as a more favourably priced expendable part, and to configure the massage device as a permanent, reusable device. This is expedient in particular because it is to be expected that the massage device will be technically considerably more complex and hence constitutes the distinctly more expensive component.

If in a preceding step a treatment has taken place on the eye with a laser, in particular with a femtosecond laser, the ring elements can be adapted to the size and shape of the laser pattern. With a ring-shaped laser pattern, it is expedient to arrange the ring elements so that they come to lie between the laser cuts. In the case of the inner ring element, these can then have an internal diameter of the ring of approximately 1.3 mm to 2 mm. The spacing of the individual ring elements can be in the order of 0.1 mm to 0.4 mm. The thickness of the ring elements can also be arranged in this range. As the pattern of the laser which is used will always be identical, irrespective of the patient, the use of an individual massage device for different patients is possible.

Pressures in the order of 10 mm Hg to 100 mm Hg can be applied onto the cornea by the massage device. A deflection capability of from 10 □m to 1 mm of the ring elements is advantageous.

The individual ring elements can be provided with springs. If pressure is applied onto a ring element, the spring expands. If the pressure is removed again, the spring moves back into a state of rest.

The massage device can also have several ring segments. This is expedient in particular when, in a preceding laser treatment, a radial cut pattern has been used. The ring segments can be arranged in a ring element in particular in the order of 10 mm to 15 mm internal diameter. This can have in particular a width of 2 mm to 5 mm. The width of a ring segment can likewise be 2 mm to 5 mm.

Both the ring elements and also the ring segments can be moved with respect to each other. In particular they can be moved here in an opposing manner into adjacent elements. However, an undulating movement of the various elements is also conceivable.

The massage device can be automated. Thus, complex movement patterns of the elements with respect to each other can be carried out in a short time. In addition, a standardization of the use of the massage device is possible. A manual operation of the massage device is, however, also conceivable.

A further aspect of the invention relates to a film for placing on the eye, in particular between the eye and a template according to the invention, wherein the template can be made from acrylic, in particular hydrophilic acrylic or silicone. Such a film has the advantage that the compressive and shearing forces occurring during the massage do not act directly onto the cornea. Thereby, an injury to the cornea, in particular to the upper cell layers, can be prevented. At the same time, the film must be sufficiently thin and flexible in order to enable a sufficient transmission of pressure changes either by massage or by the generation of a vacuum onto the cornea. The film can also be circular and can thus be adapted to the geometry of the template. It is also conceivable that the template already has a device into which the film can be clamped.

A further aspect of the invention relates to a method for the production of such a template, wherein a first concavity is shaped in accordance with a desired vision correction. The desired corneal curvature is calculated here. The concavity is shaped accordingly in mirror image to the desired and calculated corneal curvature.

This can occur both for the first concavity on its own and also for a combination of the first concavity and the second concavity.

Finally, the production of the second concavity can be formed with the aid of data from a 3D representation of a surface of an eye of a patient. This has the advantage that the template lies in an accurately fitting manner on the cornea of the patient.

A last aspect of the invention relates finally to the use of such a template, wherein in a first step the template is placed onto the eye and in a second step the pressure ratio between the eye and the cavity formed by the concavity is adapted so that a vacuum occurs in the concavity.

The cornea is thus pressed into the concavity. This can either take place in that the pressure in the eye is increased or in that the pressure in the cavity is reduced.

The method can have an intercalated step, in which the eye is massaged. Thereby also a pressure or respectively a traction can be exerted onto the cornea. This can therefore also replace the second step entirely.

In a preceding step, a treatment of the ametropia can take place with a laser. In particular, in a preceding step the stoma of the cornea can be incised by means of a femtosecond laser, without the membranes lying thereabove and therebeneath being damaged. Thus, the cornea can be subsequently drawn easily and permanently into the desired shape provided by the template.

In a further, also preceding step, a film according to the invention can be placed on the eye. This protects the cornea from injury.

The invention is explained in further detail below with the aid of three example embodiments with reference to the drawings.

Herein there are shown

FIG. 1 a diagrammatic three-dimensional illustration of a template,

FIG. 2 a possible cross-section through a template and

FIG. 3 a cross-section through a template for presbyopia correction with simultaneous correction of hypermetropia or respectively myopia and

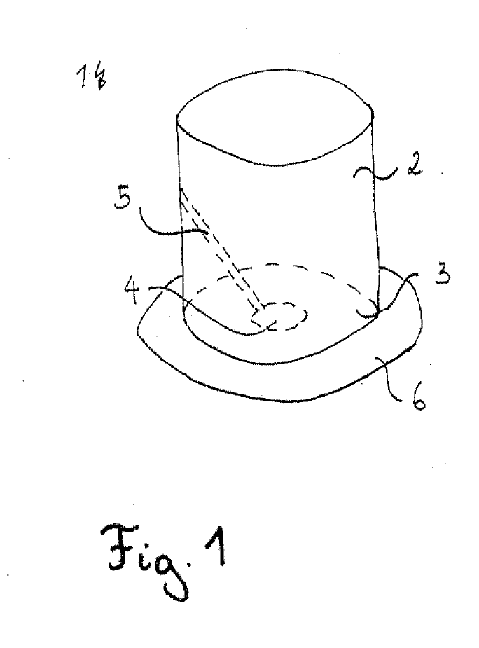

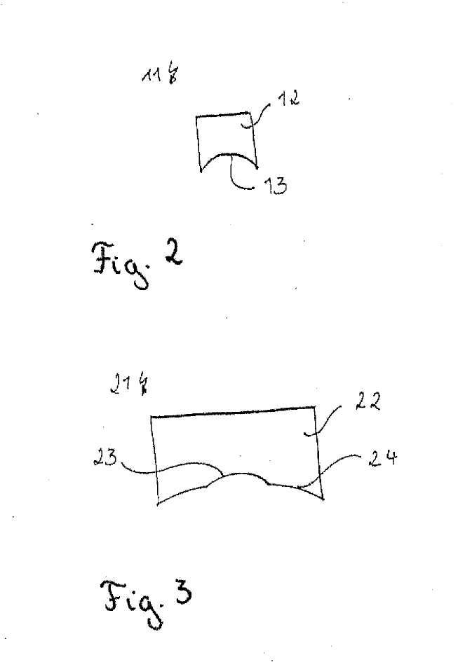

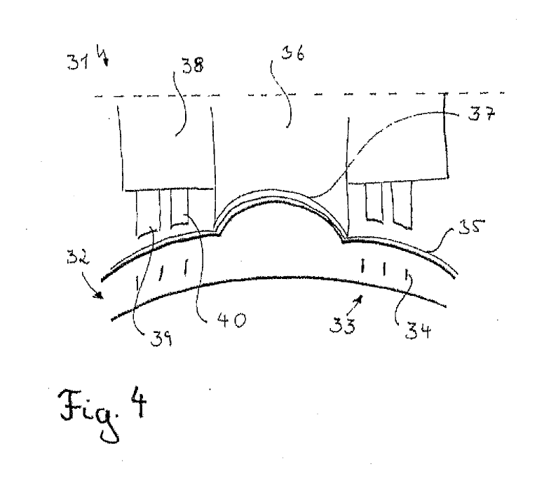

FIG. 4 a diagrammatic cross-section through a cutout of a template with a massage device on a cornea treated with a femtosecond laser.

The template 1 in FIG. 1 consists substantially of a template base body 2, on the underside 3 of which a concavity 4 is situated. A duct 5, by means of which a vacuum can be applied to the concavity runs to this concavity 4. Such a template is placed on an eye by means of the lower side 3. If then a vacuum is applied to the concavity 4 by means of a suitable device (not illustrated), such as a vacuum pump or a balloon, then the cornea is drawn into the concavity 4.

For better sealing, the underside 4 can be configured in the region around the concavity so that it is adapted to the surface of the eye and terminates therewith in as accurately fitting a manner as possible. In a two-part treatment in the region of the concavity 4 and in the region of the ring-shaped part of the underside 3 around the concavity 4 it is possible that this ring-shaped part of the underside 3 also has a corresponding arching. Both the arching of this region and also that of the concavity 4 behave in the manner of a mirror image to the desired corneal curvature which is to be achieved by the treatment.

In order to achieve a better sealing on applying of the vacuum, it is possible in addition that the template 1 has a sealing ring 6 as a seal. This can be made of silicone, for example.

The diagrammatic cross-section through a template 11, illustrated in FIG. 2, shows a possible configuration of the template base body 12, the lower side of which consists almost entirely of a concavity 13.

In the diagrammatic cross-section through a template 21 illustrated in FIG. 3, the template base body 22 is configured so that in addition to a first concavity 23, a second ring-shaped curved region 24 is provided. The first region 23 here corresponds in shape in mirror image to the desired corneal curvature in this region. The second region 24 can either be matched to the pre-operative shape of the patient's cornea before the treatment and then serves only for sealing. However, it is also possible to additionally shape the second region in mirror image in the form of a corneal curvature which is to be achieved after the operation. The cornea is then also drawn into the desired shape in this region by vacuum generation.

The template 31 is placed on a laser-treated cornea 32 with a ring-shaped laser cut pattern 33 with several ring-shaped cuts, such as for example the cut 34. The film 35 is situated between the template 31 and the cornea 32. The template 31 consists of an inner part 36 with a concavity 37. Around the latter a ring-shaped second part, the massage device 38, is situated. This has several ring segments 39 and 40. These are coordinated in their size to the cut pattern, so that they come to lie between the cuts. The inner part of the template 36 has a width of approximately 1.6 mm. The distance from the centre of one of the ring elements 39 to the next ring element 40 corresponds to approximately 2 mm. When the ring elements 39, 40 are moved with respect to each other, a massage of the cornea 32 takes place. If subsequently a vacuum is applied to the concavity 37, through the loosening of the cuts, such as for example 34, the cornea 32 can be more easily drawn into the concavity 37.

1. A template for placing on an eye, wherein it has on one side a circular concavity which is shaped in accordance with a desired vision correction and the pressure conditions between the eye and the template in a cavity formed between the cornea and the concavity are able to be altered so that the cornea is pressed or respectively drawn into the concavity.

2. The template according to claim 1, wherein around the first concavity it has a second concavity in the form of a region which is curved in a ring shape.

3. The template according to claim 1, wherein it has a duct which is connected with a concavity.

4. The template according to claim 3, wherein a device for generating vacuum is arranged on the duct.

5. The template according to claim 1, wherein the side with the concavity has a seal at the edge.

6. The template according to claim 1, wherein it is cylindrical.

7. The template according to claim 1, wherein it has a diameter of 2 to 20 mm.

8. The template according to claim 1, wherein a concavity has a diameter of 2 to 15 mm.

9. The template according to claim 1, wherein the first concavity has a depth of 2 to 8 μm.

10. The template according to claim 1, wherein the template is made from plastic.

11. The template according to claim 1, wherein it is made from titanium.

12. The template according to claim 1, wherein it has a massage device.

13. The template according to claim 12, wherein the massage device is circular.

14. The template according to claim 12, wherein the massage device has at least one ring element.

15. The template according to none claim 12, wherein the massage device has several ring segments.

16. A device according to claim 12, wherein the massage device is automated.

17. A film for placing on an eye, in particular between an eye and a template according to claim 1, wherein the film is made from acrylic or silicone.

18. A method for the production of a device in particular of a template according to claim 1, wherein a concavity is shaped in accordance with a desired vision correction.

19. The method according to claim 18, wherein the production of a second concavity is shaped with the aid of data of a 3D representation of an eye surface of a patient.

20. A use of a template according to claim 1, wherein in a first step the template is placed onto the eye and in a second step the pressure ratio between the eye and the cavity formed by the concavity is adapted such that a vacuum occurs in the concavity.

21. The use according to claim 20, wherein the cornea of the eye is massaged in an intercalated step.

22. The use according to claim 20, wherein in a preceding step a film made from acrylic or silicone is placed on the eye.
